(19) United States
(12) Patent Application Publication
(10) Pub. No.: US 2023/0418175 A1
(43) Pub. Date: Dec. 28, 2023

(54) TONER

(71) Applicant: CANON KABUSHIKI KAISHA, Tokyo (JP)

(72) Inventors: KENTARO YAMAWAKI, Shizuoka (JP); SHOTARO NOMURA, Shizuoka (JP); KENJI AOKI, Shizuoka (JP); YU YOSHIDA, Shizuoka (JP)

(21) Appl. No.: 18/339,830

(22) Filed: Jun. 22, 2023

(30) Foreign Application Priority Data
Jun. 22, 2022 (JP) 2022-100447

(51) Int. Cl. G03G 9/087; C08F 265/06; G03G 9/097

(52) U.S. Cl. CPC G03G 9/08733; C08F 265/06; G03G 9/09791; C08F 2810/20

(57) ABSTRACT

A toner comprising a toner particle, the toner particle comprising a binder resin, the binder resin comprises a crystalline resin A, the crystalline resin A comprises a monomer unit (a) having specific structure, when, in measurement of viscoelasticity of the toner, T1 (° C.) represents a temperature at which a storage elastic modulus G′ of the toner is 1.0×10⁷ Pa, tan δ(T1) represents a ratio (tan δ) of a loss elastic modulus G″ of the toner to the storage elastic modulus G′ of the toner at the temperature T1 (° C.), and tan δ(T1-10) represents tan δ at a temperature T1-10 (° C.), the T1, the tan δ(T1), and the tan δ(T1-10) satisfy specific relationship, and the toner particle comprises a linear fatty acid metal salt having a valency of 2 or more.

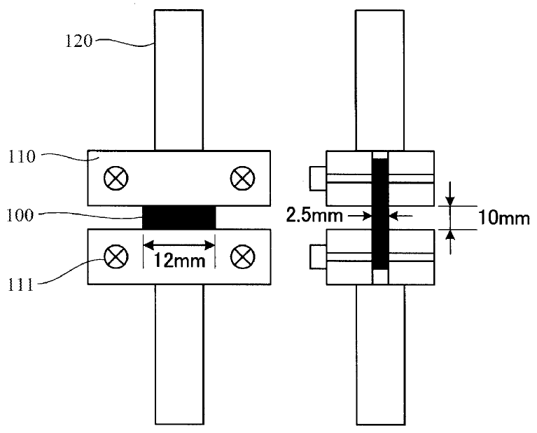

### BACKGROUND OF THE INVENTION

### Field of the Invention

The present disclosure relates to a toner for use in electrophotography and electrostatic recording.

### Description of the Related Art

Energy saving in electrophotography apparatuses is considered to be a big technical issue, and a significant reduction in energy applied to fixing apparatuses has been considered. In particular, technology for improving so-called “low-temperature fixability” of toners, which enables fixing of the toners with lower energy, has been investigated.

As a method for enabling fixation of a toner at low temperatures, a technique in which a crystalline resin is used as the binder resin has been investigated. Crystalline resin has a characteristic of hardly softening at temperatures lower than the melting point due to regular arrangement of molecular chains. On the other hand, crystals of crystalline resin rapidly melts when the temperature exceeds the melting point, and the viscosity rapidly decreases as the crystals melt. Therefore, crystalline resin has excellent sharp melt properties and the crystalline resin is attracting attention as materials that have the low-temperature fixability.

Commonly, a crystalline vinyl resin has a long-chain alkyl group as a side chain, and shows crystallinity due to long-chain alkyl groups, which are side chains, being oriented to each other. Japanese Patent Application Publication No. 2020-173414 discloses, as a toner in which a crystalline vinyl resin is used, a toner obtained using a crystalline vinyl resin that is obtained by copolymerizing a polymerizable monomer having a long-chain alkyl group and an amorphous polymerizable monomer having a different SP value.

Moreover, Japanese Patent Application Publication No. 2018-151619 discloses a toner in which the amount of a gel component having high elasticity is increased by adding, or increasing the amount of, a polymerizable crosslinking agent in order to suppress a decrease in hot-offset resistance and heat-resistant storability that is caused by adding a crystalline resin for the purpose of improving the low-temperature fixability.

However, when the amount of the crystalline resin component in the toner disclosed in Japanese Patent Application Publication No. 2020-173414 is increased to meet a demand for higher low-temperature fixability, occurrence of hot offset due to low elasticity of the crystalline resin during melting of the toner, and gloss uniformity on rough paper with large unevenness become issues. Also, when the degree of crosslinking of the gel in the toner disclosed in Japanese Patent Application Publication No. 2018-151619 is increased, the compatibility between another binder resin component with low elasticity and the gel component with high elasticity decreases. Accordingly, the increase in the degree of crosslinking of the gel causes, on the contrary, separation of the other low-viscosity component, and thus the effects of suppressing hot offset and improving gloss uniformity on rough paper are limited. Also, there is a disadvantage in that the low-temperature fixability is inhibited.

### SUMMARY OF THE INVENTION

The present disclosure provides a toner that has excellent low-temperature fixability, heat-resistant storability, and hot-offset resistance, and shows excellent gloss uniformity on rough paper.

The present disclosure relates to a toner comprising a toner particle comprising a binder resin, wherein the binder resin comprises a crystalline resin A,
where, (i) the crystalline resin A comprises a monomer unit (a) represented by formula (1):

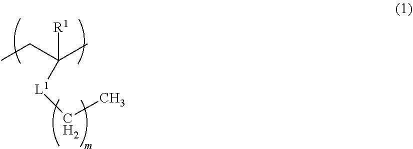

In the formula (1), R¹ represents a hydrogen atom or a methyl group, L¹ represents a single bond, an ester bond, or an amide bond, and m represents an integer from 15 to 30.

(ii) A percentage of a content of the monomer unit (a) in the crystalline resin A is 30.0 mass % or more, (iii) the monomer unit (a) comprises an alkyl group of which carbon number C(a) is 16 to 31, and (iv) a content of the crystalline resin A in the toner is 20.0 to 90.0 mass %, when, in measurement of viscoelasticity of the toner, T1 [° C.] represents a temperature at which a storage elastic modulus G′ of the toner is 1.0×10⁷ Pa, tan δ(T1) represents a ratio (tan δ) of a loss elastic modulus G″ of the toner to the storage elastic modulus G′ of the toner at the temperature T1 [° C.], and tan δ(T1-10) represents tan δ at a temperature T1-10 [° C.], the T1, the tan δ(T1), and the tan δ(T1-10) satisfy expressions (2) to (4) below

50.0≤T1≤70.0 (2)

0.3≤tan δ(T1)≤1.0 (3)

1.0≤tan δ(T1)/tan δ(T1-10)≤1.9 (4)

Where, the toner particle comprises a linear fatty acid metal salt, a carbon number C(a) of the alkyl group and a carbon number C(b) of a linear fatty acid in the linear fatty acid metal salt satisfy |C(a)−C(b)|≤10, and a metal in the linear fatty acid metal salt has a valency of 2 or more.

With the present disclosure, it is possible to provide a toner that has excellent low-temperature fixability, heat-resistant storability, and hot-offset resistance, and shows excellent gloss uniformity on rough paper. Further features of the present disclosure will become apparent from the following description of exemplary embodiments with reference to the attached drawings.

### BRIEF DESCRIPTION OF THE DRAWINGS

The FIGURE shows an example of a manner in which a sample is attached in viscoelasticity measurement.

### DESCRIPTION OF THE EMBODIMENTS

In the present disclosure, the wordings “from XX to YY” and “XX to YY” expressing numerical value ranges mean numerical value ranges including the lower limit and the upper limit as endpoints, unless otherwise stated. When numerical value ranges are described stepwise, upper limits and lower limits of those numerical value ranges can be combined suitably. The term “(meth)acrylic acid ester” means an acrylic acid ester and/or a methacrylic acid ester.

The term “monomer unit” refers to a reacted form of a monomer material included in a polymer. For example, a section including a carbon-carbon bond in a main chain of a polymer formed through polymerization of a vinyl monomer will be referred to as a single unit. A vinyl monomer can be represented by the following formula (C).

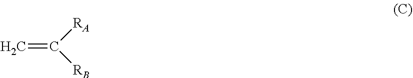

In the formula (C), R_{A} represents a hydrogen atom or an alkyl group (preferably, an alkyl group having 1 to 3 carbon atoms, and more preferably a methyl group), and R_{B} represents any substituent. The term “crystalline resin” refers to a resin that has a clear endothermic peak in differential scanning calorimetry (DSC).

The inventors of the present disclosure conducted research in order to solve the issues. A process for fixing a toner to paper can be divided into roughly three steps. Specifically, the process can be divided into (1) a step in which a toner melts and penetrates paper, (2) a step in which the toner and a fixing member are separated, and (3) a step in which the toner is cooled and solidified on the paper and is then fixed on the paper.

Properties required for the toner in the three steps described above differ from one another. In the step (1), the melt viscosity of the toner is required to be low. Since the toner easily penetrates paper due to low melt viscosity, there is no need to excessively heat the toner to melt it, and thus excellent low-temperature fixability can be exhibited.

Meanwhile, in the step (2), the melt viscosity of the toner is required to be high. If the melt viscosity is low, the melted toner remains adhering to the paper and the fixing member, and thus hot offset is likely to occur.

In the step (3), the melt viscosity of the toner is required to be appropriately low. If the melt viscosity is high, the melted toner cannot be sufficiently leveled, and thus the gloss of a fixed image is likely to become un-uniform. However, if the melt viscosity is too low, gloss is likely to be un-uniform on rough paper with large unevenness.

When an attempt is made to satisfy the toner properties required in the steps (1) and (2), which are mutually contradictory as described above, as well as the property required in the step (3), there seems to be a limitation on use of the polymer design as in the conventional technology to satisfy the low-temperature fixability, the hot-offset resistance, and the gloss uniformity on rough paper.

In order to solve the aforementioned issues, the inventors of the present disclosure conducted research on technology capable of achieving both of the above-mentioned contradictory toner properties based on a mechanism different from the conventional polymer design. Specifically, since the toner is softened through the application of heat and pressure in the fixing process, they thought that the issues could be solved by utilizing this phenomenon to control the molecular state in the toner. Hereinafter, aspects for achieving this will be described.

The inventors of the present disclosure found that a toner that has excellent low-temperature fixability, heat-resistant storability, and hot-offset resistance, and shows excellent gloss uniformity on rough paper can be provided by controlling the molecular state in the toner as follows. A toner comprising a toner particle comprising a binder resin, wherein the binder resin comprises a crystalline resin A, (i) the crystalline resin A comprises a monomer unit (a) represented by the following formula (1):

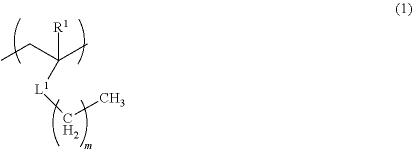

in the formula (1), R¹ represents a hydrogen atom or a methyl group, L¹ represents a single bond, an ester bond, or an amide bond, and m represents an integer from 15 to 30,
(ii) a percentage of a content of the monomer unit (a) in the crystalline resin A is 30.0 mass % or more, (iii) the monomer unit (a) comprises an alkyl group of which carbon number C(a) is 16 to 31, and (iv) a content of the crystalline resin A in the toner is 20.0 to 90.0 mass %, when, in measurement of viscoelasticity of the toner, T1 [° C.] represents a temperature at which a storage elastic modulus G′ of the toner is 1.0×10⁷ Pa, tan δ(T1) represents a ratio (tan δ) of a loss elastic modulus G″ of the toner to the storage elastic modulus G′ of the toner at the temperature T1 [° C.], and tan δ(T1-10) represents tan δ at a temperature T1-10 [° C.], the T1, the tan δ(T1), and the tan δ(T1-10) satisfy expressions (2) to (4) below

50.0≤T1≤70.0 (2)

0.3≤tan δ(T1)≤1.0 (3)

1.0 tan δ(T1)/tan δ(T1-10)≤1.9 (4)

where, the toner particle comprises a linear fatty acid metal salt, a carbon number C(a) of the alkyl group and a carbon number C(b) of a linear fatty acid in the linear fatty acid metal salt satisfy |C(a)−C(b)|≤10, and a metal in the linear fatty acid metal salt has a valency of 2 or more.

In order to allow the toner to exhibit the low-temperature fixability while ensuring the heat-resistant storability of the toner, the storage elastic modulus needs to be high until the temperature of the toner reaches a temperature which is required for the heat-resistant storability, and the storage elastic modulus needs to rapidly decrease when the temperature of the toner becomes higher than that temperature, or in other words, the toner needs to have sharp melt properties. As described above, examples of materials having sharp melt properties include crystalline resins.

The toner of the present disclosure comprises a toner particle comprising a binder resin. The binder resin comprises a crystalline resin A. The crystalline resin A comprises a monomer unit (a) represented by the following formula (1).

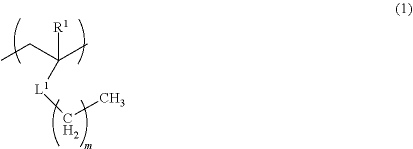

In the formula (1), R¹ represents a hydrogen atom or a methyl group, L¹ represents a single bond, an ester bond, or an amide bond, and m represents an integer from 15 to 30. L¹ is preferably an ester bond, and it is more preferable that a carbonyl in an ester bond —COO— is linked to a carbon atom with R¹.

The percentage of the content of the monomer unit (a) in the crystalline resin A is 30.0 mass % or more. When the content of the monomer unit (a) in the crystalline resin A is 30.0 mass % or more, side chains are oriented to each other, and thus the crystalline resin A can show crystallinity. As a result, the low-temperature fixability is improved.

The percentage of the content of the monomer unit (a) in the crystalline resin A is preferably 50.0 mass % or more because the crystalline resin A tends to show crystallinity. The percentage of the content of the monomer unit (a) in the crystalline resin A is more preferably 60.0 mass % or more, and particularly preferably 70.0 mass % or more. Although there is no particular limitation on the upper limit, the percentage of the content of the monomer unit (a) in the crystalline resin A is preferably 90.0 mass % or less from the viewpoint of the heat-resistant storability, and more preferably 85.0 mass % or less. For example, the percentage of the content of the monomer unit (a) in the crystalline resin A is preferably 50.0 to 90.0 mass %, 60.0 to 90.0 mass %, 70.0 to 90.0 mass %, 60.0 to 85.0 mass %, or 70.0 to 85.0 mass %.

The monomer unit (a) represented by the formula (1) comprises an alkyl group of which carbon number C(a) is 16 to 31. As described above, a crystalline vinyl resin has a long-chain alkyl group as a side chain, and shows crystallinity due to long-chain alkyl groups, which are side chains, being oriented to each other. The monomer unit (a) can form a linear alkyl group side chain that can show crystallinity because the carbon number C(a) of the alkyl group in the monomer unit (a) is 16 or greater. Also, it is possible to suppress an excessive increase in the melting point of the resin because the carbon number C(a) of the alkyl group in the monomer unit (a) is 31 or smaller. Accordingly, when the carbon number C(a) falls within the range above, the crystalline resin A tends to show crystallinity, and excellent low-temperature fixability can be exhibited.

The lower limit of the carbon number C(a) of the monomer unit (a) is preferably 18 or greater, and more preferably 20 or greater. The upper limit of the carbon number C(a) is preferably 28 or smaller, and more preferably 24 or smaller. For example, the carbon number C(a) is preferably 18 to 28, or 20 to 24.

The amount of the crystalline resin A in the toner is 20.0 to 90.0 mass %. When the amount of the crystalline resin A in the toner is 20.0 mass % or more, crystallinity is sufficiently shown, and favorable low-temperature fixability can be exhibited. Meanwhile, when the amount is 90.0 mass % or less, the melt viscosity can be kept within an appropriate range when the toner is fixed. Accordingly, when the amount of the crystalline resin A falls within the range above, it is possible to suppress the occurrence of hot offset, a decrease in gloss uniformity of a fixed image, a decrease in heat-resistant storability, and the like while achieving low-temperature fixability.

The lower limit of the amount of the crystalline resin A relative to the mass of the toner is more preferably 30.0 mass % or more, even more preferably 35.0 mass % or more, and particularly preferably 40.0 mass % or more. The upper limit thereof is more preferably 85.0 mass % or less, even more preferably 75.0 mass % or less, and particularly preferably 65.0 mass % or less. For example, the amount thereof is preferably 30.0 to 85.0 mass %, 35.0 to 75.0 mass %, or 40.0 to 65.0 mass %.

The melt viscosity of the binder resin having sharp melt properties is low at temperatures higher than or equal to the melting point, and thus hot offset is likely to occur. Accordingly, the configuration above itself has no sufficient countermeasure against hot offset and the like. In the conventional technology, a crosslinking agent is typically added to take a countermeasure against hot offset. This makes it possible to increase the amount of a gel portion, which is a highly crosslinked portion, and thus improve the high-temperature elasticity of the toner. However, a highly crosslinked gel portion tends to separate from other resin components, and when a large amount of the crosslinking agent is added, the effects thereof tend to saturate. Also, the presence of a separated low-elasticity component causes hot offset or a decrease in gloss uniformity. Furthermore, the method described above has many adverse effects such as impairment of low-temperature fixability.

The toner particle comprises a linear fatty acid metal salt, the carbon number C(a) of the alkyl group comprised in the monomer unit (a) and the carbon number C(b) of the linear fatty acid in the linear fatty acid metal salt satisfy |C(a)−C(b)|≤10, and the metal in the linear fatty acid metal salt has a valency of 2 or more. When these conditions are satisfied, both the low-temperature fixability and the hot-offset resistance can be realized. Note that, in the present disclosure, the expression “the metal in the linear fatty acid metal salt has a valency of 2 or more” means that the metal is a metal species of which a single-component metal ion can take on a valency of 2 or more.

When |C(a)−C(b)|≤10 is satisfied, the carbon number of the alkyl group in the monomer unit (a) is close to the carbon number of the linear fatty acid in the linear fatty acid metal salt. Commonly, alkyl chains whose carbon numbers are close to each other have a high affinity for each other. When the toner particle comprises a linear fatty acid metal salt with a carbon number close to the carbon number of the alkyl group in the monomer unit (a) having crystallinity, the affinity between the monomer unit (a) and the linear fatty acid metal salt is increased, thus making it possible to improve the compatibility therebetween.

Furthermore, when the carbon numbers are close to each other, it is also possible to maintain the crystallinity without disturbing the orientation of the side chains in the crystalline resin A, and it is thus conceivable that a state in which the crystalline resin A and the linear fatty acid metal salt form a eutectic-like structure can be produced. Maintaining the crystallinity of the crystalline resin A as described above makes it possible to introduce a linear fatty acid metal salt into the crystalline resin A while the heat-resistant storability and the low-temperature fixability of the toner are maintained.

The upper limit of |C(a)−C(b)| is preferably 8 or smaller, and more preferably 5 or smaller. The lower limit thereof is not particularly limited, but is preferably 1 or greater, and more preferably 3 or greater. For example, |C(a)−C(b)| is preferably 1 to 8, or 3 to 5. When the condition above is satisfied, more favorable effects on realization of both the low-temperature fixability and the heat-resistant storability can be obtained.

The carbon number C(b) of the linear fatty acid in the linear fatty acid metal salt is not particularly limited, but is preferably 6 or greater, more preferably 12 or greater, and even more preferably 16 or greater. The carbon number C(b) is preferably 30 or smaller, more preferably 26 or smaller, and even more preferably 22 or smaller. For example, the carbon number C(b) is preferably 6 to 30, 12 to 26, or 16 to 22.

In the present disclosure, the metal in the linear fatty acid metal salt comprised in the toner particle has a valency of 2 or more. It was found that, when the condition above is satisfied, the hot-offset resistance of the toner can be improved. As described above, in order to improve the hot-offset properties in the step in which the toner and the fixing member are separated, the melt viscosity of the melted toner is required to be high.

A fatty acid metal salt comprising a metal having a valency of 2 or more often has two or more alkyl chains, and has high degree of compatibility with an alkyl chain in another binder resin molecule. It is inferred that, as a result, when the toner melts in the fixing process and thus the molecular chains can move, a quasi-crosslinked state is produced due to a fatty acid metal salt introduced to the molecular chain of the crystalline resin being also introduced to the molecular chain of another crystalline resin, thus making it possible to improve the melt viscosity.

Also, the greater the electric charge of the metal in the linear fatty acid metal salt is, the more easily the metal can interact with a polar group of the binder resin, and therefore, it is conceivable that the hot-offset resistance of the toner is improved due to the metal being a polyvalent metal having a valency of 2 or more. The metal in the linear fatty acid metal salt is preferably a trivalent metal.

Although the linear fatty acid metal salt may comprise a single linear fatty acid or a plurality of linear fatty acids, it is preferable that the linear fatty acid metal salt comprises a plurality of linear fatty acids. It is conceivable that, when the linear fatty acid metal salt comprises a plurality of linear fatty acids, a metal in the fatty acid metal salt bound to one binder resin molecule interacts with a hydroxy group in the fatty acid metal salt bound to another binder resin molecule, and therefore, it is preferable that the linear fatty acid metal salt comprises a plurality of linear fatty acids from the viewpoint of exhibiting the effects above.

The amount of the metallic element in the toner particle is 5.0 to 200.0 mass ppm. When the amount of the metallic element in the toner particle is 5.0 mass ppm or more, the melt viscosity is increased, thus making it possible to improve the hot-offset resistance. Also, when the amount is 200.0 mass ppm or less, an excessive increase in the melt viscosity is suppressed, thus making it possible to suppress a decrease in low-temperature fixability to a slight degree.

The lower limit of the amount of the metal in the toner particle is preferably 10.0 mass ppm or more, more preferably 30.0 mass ppm or more, and even more preferably 50.0 mass ppm or more. The upper limit thereof is preferably 190.0 mass ppm or less, more preferably 170.0 mass ppm or less, and even more preferably 150.0 mass ppm or less. For example, the amount thereof is preferably 10.0 to 190.0 mass ppm, 30.0 to 170.0 mass ppm, or 50.0 to 150.0 mass ppm.

Regarding the toner, when T1 [° C.] represents a temperature at which the storage elastic modulus G′ of the toner is 1.0×10⁷ Pa in measurement of viscoelasticity of the toner, T1 satisfies the expression (2) below.

50.0≤T1≤70.0 (2)

T1 represents a temperature at which the elastic modulus corresponds to a state in which the toner is sharply melting. When T1 is 50.0° C. or higher, the toner is not denatured even in a high-temperature environment, and thus a decrease in the heat-resistant storability of the toner can be suppressed. Also, when T1 is 70.0° C. or lower, the toner can be melted without excessively applying heat to the toner, and can thus exhibit excellent low-temperature fixability.

T1 can be controlled by adjusting the carbon number of the side-chain alkyl group in the crystalline resin comprised in the toner, the proportion of a long-chain alkyl group in the crystalline resin, the amount of the crystalline resin A in the toner, the amount of the monomer unit (a) in the crystalline resin A, and the like.

The lower limit of T1 is preferably 53.0° C. or higher, and more preferably 55.0° C. or higher. The upper limit thereof is preferably 63.0° C. or lower, and more preferably 61.0° C. or lower. For example, T1 is preferably 53.0 to 63.0° C., or 55.0 to 61.0° C.

Regarding the toner, when, in measurement of viscoelasticity of the toner, T1 [° C.] represents a temperature at which the storage elastic modulus G′ of the toner is 1.0×10⁷ Pa, tan δ(T1) represents the ratio (tan δ) of the loss elastic modulus G″ of the toner to the storage elastic modulus G′ of the toner at the temperature T1 [° C.], and tan δ(T1-10) represents tan δ at a temperature T1-10 [° C.], the T1, the tan δ(T1), and tan δ(T1)/tan δ(T1-10) satisfy the expressions (3) and (4) below.

0.3≤tan δ(T1)≤1.0 (3)

1.0≤tan δ(T1)/tan δ(T1−10)≤1.9 (4)

When the expression (3) is satisfied, the gloss uniformity of a fixed image is improved. When the expression (4) is satisfied, both the gloss uniformity of a fixed image and the hot-offset resistance can be realized.

Commonly, the ratio (tan δ) of the loss elastic modulus G″ to the storage elastic modulus G′ indicates a degree of deformability, namely, whether the polymer material shows strong elastic properties or strong viscous properties. The smaller tan δ is, the harder it is to deform the polymer material. That is to say, the polymer material shows strong elastic properties and is in a “rubber-like” state. On the other hand, the larger tan δ is, the easier it is to deform the polymer material. That is to say, the polymer material shows strong viscous properties and is in a “gum-like” state.

When the expression (3) is satisfied, the toner has appropriate viscoelasticity when fixed at low temperatures. T1 represents a temperature at which the toner is sharply melting, and therefore, when tan δ(T1) falls within the range represented by the expression (3), a degree of deformability of the toner is appropriately maintained when the toner is fixed at low temperatures, and thus the gloss uniformity is improved.

If tan δ(T1) is smaller than 0.3, the toner shows strong elastic properties and is less likely to be deformed when fixed at low temperatures, and thus gloss of the toner fixed to rough paper deteriorates. On the other hand, if tan δ(T1) is larger than 1.0, the toner shows strong viscous properties and is likely to be deformed when fixed at low temperatures, and thus permeation of the toner into paper is facilitated, which leads to a decrease in gloss uniformity.

The lower limit of tan δ(T1) is preferably 0.4 or greater, and more preferably 0.5 or greater. The upper limit thereof is preferably 0.9 or smaller, and more preferably 0.8 or smaller. For example, tan δ(T1) is preferably 0.4 to 0.9, or 0.5 to 0.8.

tan δ(T1) can be controlled by adjusting the amount of the crystalline resin added to the toner. In particular, in the case where the crystalline resin is a vinyl resin that has a long-chain alkyl group, it is possible to control tan δ(T1) by adjusting the length of the long-chain alkyl group or the proportion of the long-chain alkyl group in a binder resin, for example. It is also possible to control tan δ(T1) by adjusting the type or addition amount of a crosslinking agent when manufacturing the toner. Specifically, tan δ(T1) can be increased by increasing the addition amount of the crystalline resin, increasing the proportion of a long-chain alkyl group in the binder resin, or reducing the amount of a crosslinking agent, for example. Also, tan δ(T1) can be reduced by reducing the addition amount of the crystalline resin, reducing the proportion of a long-chain alkyl group in the binder resin, and increasing the number of crosslinks by, for example, increasing the amount of a crosslinking agent.

The value of tan δ(T1)/tan δ(T1-10) represents a change in tan δ in a temperature region around T1 at which the toner is sharply melting. In the case of a toner in which a change in tan δ in a temperature region around T1 is small, an appropriate amount of the fatty acid metal salt out-migrates when the toner is fixed, and hot offset is further suppressed due to the releasing effect of the fatty acid metal salt. Also, when the expression (4) is satisfied, the toner is appropriately leveled in a fixed image, thus making it possible to achieve gloss and gloss uniformity.

If tan δ(T1)/tan δ(T1-10) is smaller than 1.0, the toner is less likely to be deformed when it sharply melts, and thus the gloss deteriorates. On the other hand, if tan δ(T1)/tan δ(T1-10) is greater than 1.9, the toner undergoes a rapid change from elastic properties to viscous properties around temperatures at which the toner starts to melt. Therefore, when the toner is fixed at low temperatures, deformation of the toner is further facilitated on protruded portions of paper and further suppressed in depressed portions of paper. As a result, the gloss uniformity decreases.

The lower limit tan δ(T1)/tan δ(T1-10) is preferably 1.2 or greater, and more preferably 1.4 or greater. The upper limit thereof is preferably 1.8 or smaller, and more preferably 1.7 or smaller. For example, tan δ(T1)/tan δ(T1-10) is preferably 1.2 to 1.8, or 1.4 to 1.7.

tan δ(T1)/tan δ(T1-10) can be controlled by adjusting the amount of the crystalline resin added to the toner. In particular, in the case where the crystalline resin is a vinyl resin having a long-chain alkyl group, tan δ(T1)/tan δ(T1-10) can be controlled by adjusting the length of the long-chain alkyl group or the proportion of the long-chain alkyl group in the binder resin, for example. The tan δ(T1)/tan δ(T1-10) can also be controlled by adjusting the type or addition amount of a crosslinking agent when the toner is manufactured. Specifically, tan δ(T1)/tan δ(T1-10) can be increased by increasing the addition amount of the crystalline resin, increasing the proportion of a long-chain alkyl group in the binder resin, or reducing the amount of a crosslinking agent, for example. Also, tan δ(T1)/tan δ(T1-10) can be reduced by reducing the addition amount of the crystalline resin, reducing the proportion of a long-chain alkyl group in the binder resin, and increasing the number of crosslinks by, for example, increasing the amount of a crosslinking agent.

Regarding the toner, it is preferable that, when, in measurement of viscoelasticity of the toner, T2 [° C.] represents a temperature at which the storage elastic modulus G′ of the toner is 3.0×10⁷ Pa, and T3 [° C.] represents the storage elastic modulus G′ of the toner is 3.0×10⁶ Pa, T2 and T3 satisfies the expression (5) below.

|T3 −T2|≤10.0 (5)

T2 represents a temperature at which the elastic modulus corresponds to a state before the toner starts to melt. Also, T3 represents a temperature at which the elastic modulus corresponds to a state after the toner has melted.

T2 is preferably 45 to 65° C., and more preferably 50 to 60° C.

T3 is preferably 50 to 70° C., and more preferably 55 to 65° C.

|T3−T2| represents a temperature width between a temperature at which the toner starts to melt and a temperature at which the toner finishes melting. When the expression (5) is satisfied, the toner rapidly melts in a narrow temperature width, that is to say, the toner has excellent sharp melt properties. As a result, both the low-temperature fixability and the heat-resistant storability can be achieved in the toner.

|T3−T2| is preferably 9.0 or smaller, more preferably 8.0 or smaller, and even more preferably 7.0 or smaller. The lower limit thereof is not particularly limited, but is preferably 3.0 or greater, and more preferably 5.0 or greater. For example, |T3−T2| is preferably 3.0 to 9.0, 3.0 to 8.0, 3.0 to 7.0, or 5.0 to 7.0. |T3−T2| can be controlled by changing the proportion of the crystalline resin comprised in the toner or the proportion of a portion showing crystallinity in the crystalline resin, for example.

Hereinafter, the crystalline resin A will be specifically described. Examples of the crystalline resin A include a crystalline vinyl resin, a crystalline polyester resin, a crystalline polyurethane resin, and a crystalline epoxy resin, and a crystalline vinyl resin is preferably used. The amount of the monomer unit (a) represented by the formula (1) in the crystalline resin A is 30.0 mass % or more. The formula (1) indicates that the monomer unit (a) has a long-chain alkyl group, and the resin tends to show crystallinity due to having the long-chain alkyl group.

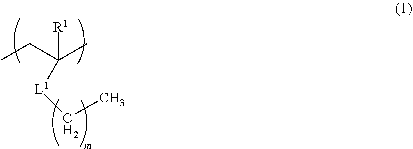

In the formula (1), R¹ represents a hydrogen atom or a methyl group, L¹ represents a single bond, an ester bond, or an amide bond, and m represents an integer from 15 to 30. L¹ is preferably an ester bond, and it is more preferable that a carbonyl in an ester bond —COO— is linked to a carbon atom with R¹.

m in the formula (1) represents an integer from 15 to 30. When m is 15 to 30, the crystalline resin A is likely to show crystallinity, thus making it possible to obtain a toner having excellent low-temperature fixability. m is preferably 17 to 29, and more preferably 19 to 23.

As a method for introducing the monomer unit (a), it is possible to use a method of polymerizing any of the following (meth)acrylic acid esters. Examples of the (meth)acrylic acid esters include (meth)acrylic acid esters that have a linear alkyl group having 16 to 36 carbon atoms [stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myricyl (meth)acrylate, dotriacontyl (meth)acrylate, etc.] and (meth)acrylic acid esters that have a branched alkyl group having 18 to 36 carbon atoms [e.g., 2-decyltetradecyl (meth)acrylate].

In the case where the crystalline resin A is a crystalline vinyl resin, the crystalline resin A can include another monomer unit in addition to the monomer unit (a). As a method for introducing the other monomer unit, it is possible to use a method of polymerizing any of the (meth)acrylic acid esters listed above and another vinyl monomer. The other monomer units may be used alone or in combination of two or more.

Examples of the other vinyl monomer include the followings. (Meth)acrylic acid esters such as styrene, α-methylstyrene, methyl (meth)acrylate, ethyl (meth)acrylate, n-butyl (meth)acrylate, t-butyl (meth)acrylate, and 2-ethylhexyl (meth)acrylate. Monomers that have a urea group, such as monomers obtained by causing a reaction between an amine having 3 to 22 carbon atoms [e.g., a primary amine (normal-butylamine, t-butylamine, propylamine, isopropylamine, etc.), a secondary amine (di-normal-ethylamine, di-normal-propylamine, di-normal-butylamine, etc.), aniline, cycloxyl amine, etc.] and an isocyanate that has an ethylenically unsaturated bond and 2 to 30 carbon atoms, by using a known method.

Monomers that have a carboxy group, such as methacrylic acid, acrylic acid, and 2-carboxyethyl (meth)acrylate.

Monomers that have a hydroxy group, such as 2-hydroxyethyl (meth)acrylate and 2-hydroxypropyl (meth)acrylate.

Monomers that have an amide group, such as acrylamides and monomers obtained by causing a reaction between an amine having 1 to 30 carbon atoms and a carboxylic acid (acrylic acid, methacrylic acid, etc.) that has an ethylenically unsaturated bond and 2 to 30 carbon atoms, by using a known method.

In particular, styrene, methacrylic acid, acrylic acid, methyl (meth)acrylate, t-butyl (meth)acrylate, acrylonitrile, and methacrylonitrile are preferably used.

The crystalline resin A preferably includes a monomer unit formed by styrene and represented by the following formula (A). Also, the crystalline resin A preferably includes a monomer unit formed by (meth)acrylic acid and represented by the following formula (B).

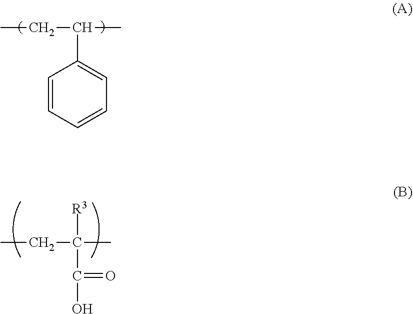

In the formula (B), R³ represents a hydrogen atom or a methyl group. R³ is preferably a methyl group.

The percentage of the content of the monomer unit formed by styrene in the crystalline resin A is preferably 1.0 to 75.0 mass %, more preferably 5.0 to 50.0 mass %, and further preferably 10.0 to 25.0 mass %. The percentage of the content of the monomer unit formed by (meth)acrylic acid (preferably methacrylic acid) in the crystalline resin A is preferably 1.0 to 5.0 mass %, more preferably 1.0 to 3.0 mass %, and further preferably 1.0 to 2.5 mass %.

In the case where the crystalline resin A is a polyester resin, it is possible to use a resin that shows crystallinity from among polyester resins that can be obtained through a reaction between a carboxylic acid having two or more carboxy groups and a polyhydric alcohol.

Examples of the carboxylic acid having two or more carboxy groups include the following compounds. Dibasic acids such as succinic acid, adipic acid, sebacic acid, phthalic acid, isophthalic acid, terephthalic acid, malonic acid, and dodecenyl succinic acid, anhydrides and lower alkyl esters of these, and aliphatic unsaturated dicarboxylic acids such as maleic acid, fumaric acid, itaconic acid, and citraconic acid.

Examples of the carboxylic acid having two or more carboxy groups also include 1,2,4-benzenetricarboxylic acid, 1,2,5-benzenetricarboxylic acid, and anhydrides and lower alkyl esters of these. These may be used alone or in combination of two or more.

Examples of the polyhydric alcohol include the following compounds. Alkylene glycols (ethylene glycol, 1,2-propylene glycol, and 1,3-propylene glycol); alkylene ether glycols (polyethylene glycol and polypropylene glycol); alicyclic diols (1,4-cyclohexanedimethanol); bisphenols (bisphenol A); and alkylene oxide (ethylene oxide and propylene oxide) adducts of alicyclic diols. Alkyl moieties in alkylene glycols and alkylene ether glycols may be linear or branched.

Examples of the polyhydric alcohol further include glycerol, trimethylolethane, trimethylolpropane, and pentaerythritol. These may be used alone or in combination of two or more.

It is also possible to use a monovalent acid such as acetic acid or benzoic acid or a monohydric alcohol such as cyclohexanol or benzyl alcohol to adjust the acid value or the hydroxyl value. Although there is no particular limitation on the method for manufacturing the polyester resin, the polyester resin can be manufactured using either a transesterification method or a direct polycondensation method or a combination of these methods.

The toner particle comprises a salt of a linear fatty acid having 6 to 30 carbon atoms with a metal having a valency of 2 or more. Although there is no particular limitation on the metal having a valency of 2 or more, examples thereof include calcium and aluminum.

For example, the salt may include at least one compound selected from the group consisting of zinc octylate, magnesium distearate, aluminum distearate, calcium distearate, zinc distearate, calcium montanate, calcium laurate, barium laurate, calcium ricinoleate, barium ricinoleate, zinc ricinoleate, and the like.

The binder resin may comprise an amorphous resin in addition to the crystalline resin A. Examples of the amorphous resin include a vinyl resin, a polyester resin, a polyurethane resin, and an epoxy resin, and a vinyl resin such as polystyrene is preferably used.

Examples thereof include styrene derivatives such as α-methylstyrene, (3-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyren, and (meth)acrylic acid esters.

The amount of the crystalline resin A in the binder resin is preferably 20.0 to 90.0 mass %, more preferably 30.0 to 85.0 mass %, and even more preferably 40.0 to 65.0 mass %.

The amount of the amorphous resin in the binder resin is preferably 10.0 to 80.0 mass %, more preferably 20.0 to 70.0 mass %, and even more preferably 30.0 to 60.0 mass %.

The binder resin may comprise a crosslinking agent as necessary. For example, the following compounds can be used as the crosslinking agent, but there is no limitation thereto: ethylene glycol dimethacrylate, ethylene glycol diacrylate, diethylene glycol dimethacrylate, diethylene glycol diacrylate, triethylene glycol dimethacrylate, tryethylene glycol diacrylate, neopentyl glycol dimethacrylate, neopentyl glycol diacrylate, divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycol #200, #400, and #600, dipropylene glycol diacrylate, polypropylene glycol diacrylate, and polyester-type diacrylates (MANDA, Nippon Kayaku Co., Ltd.), and compounds obtained by replacing acrylate in the compounds above with methacrylate. The amount of the crosslinking agent in the binder resin is preferably 0.01 to 10.00 mass %, and more preferably 0.03 to 5.00 mass %.

The toner may comprise a release agent. Examples of the release agent include hydrocarbon-based waxes and ester waxes. Use of a hydrocarbon wax and/or an ester wax makes it easy to achieve effective releasability.

The hydrocarbon wax is not particularly limited, but examples thereof are as follows. Aliphatic hydrocarbon waxes: low molecular weight polyethylene, low molecular weight polypropylene, low molecular weight olefin copolymers, Fischer Tropsch waxes, and waxes obtained by subjecting these to oxidation or acid addition.

The ester wax should have at least one ester bond per molecule, and may be a natural ester wax or a synthetic ester wax. Ester waxes are not particularly limited, but examples thereof are as follows: Esters of a monohydric alcohol and a monocarboxylic acid, such as behenyl behenate, stearyl stearate and palmityl palmitate; Esters of a dicarboxylic acid and a monoalcohol, such as dibehenyl sebacate; Esters of a dihydric alcohol and a monocarboxylic acid, such as ethylene glycol distearate and hexane diol dibehenate; Esters of a trihydric alcohol and a monocarboxylic acid, such as glycerol tribehenate; Esters of a tetrahydric alcohol and a monocarboxylic acid, such as pentaerythritol tetrastearate and pentaerythritol tetrapalmitate; Esters of a hexahydric alcohol and a monocarboxylic acid, such as dipentaerythritol hexastearate, dipentaerythritol hexapalmitate and dipentaerythritol hexabehenate; Esters of a polyfunctional alcohol and a monocarboxylic acid, such as polyglycerol behenate; and natural ester waxes such as carnauba wax and rice wax.

Of these, esters of a hexahydric alcohol and a monocarboxylic acid, such as dipentaerythritol hexastearate, dipentaerythritol hexapalmitate and dipentaerythritol hexabehenate, are preferred.

The release agent may be a hydrocarbon-based wax or an ester wax in isolation, a combination of a hydrocarbon-based wax and an ester wax, or a mixture of two or more types of each. In particular, it is preferable to use a hydrocarbon-based wax, and it is preferable to use a hydrocarbon-based wax alone, or use a mixture of two or more types of hydrocarbon-based waxes.

In the toner, the release agent has a content of preferably from 1.0 to 30.0 mass %, or more preferably from 2.0 to 25.0 mass % in the toner particle. If the content of the release agent in the toner particle is within this range, the release properties are easier to secure during fixing. The melting point of the release agent is preferably from 60 to 120° C. If the melting point of the release agent is within this range, it is more easily melted and exuded on the toner particle surface during fixing, and is more likely to provide release effects. The melting point is more preferably from 70 to 100° C.

The toner may also contain a colorant. Examples of colorants include known organic pigments, organic dyes, inorganic pigments, and carbon black and magnetic particles as black colorants. Other colorants conventionally used in toners may also be used. Examples of yellow colorants include condensed azo compounds, isoindolinone compounds, anthraquinone compounds, azo metal complexes, methine compounds and allylamide compounds. Specifically, C.I. pigment yellow 12, 13, 14, 15, 17, 62, 74, 83, 93, 94, 95, 109, 110, 111, 128, 129, 147, 155, 168 and 180 can be used by preference.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds and perylene compounds. Specifically, C.I. pigment red 2, 3, 5, 6, 7, 23, 48:2, 48:3, 48:4, 57:1, 81:1, 122, 144, 146, 166, 169, 177, 184, 185, 202, 206, 220, 221 and 254 can be used by preference. Examples of cyan colorants include copper phthalocyanine compounds and their derivatives, anthraquinone compounds, and basic dye lake compounds. Specifically, C.I. pigment blue 1, 7, 15, 15:1, 15:2, 15:3, 15:4, 60, 62 and 66 can be used by preference.

The colorants are selected based on considerations of hue angle, chroma, lightness, weather resistance, OHP transparency, and dispersibility in the toner. The content of the colorant is preferably from 1.0 to 20.0 mass parts per 100.0 mass parts of the binder resin. When a magnetic particle is used as the colorant, the content thereof is preferably from 40.0 to 150.0 mass parts per 100.0 mass parts of the binder resin.

A charge control agent may be included in the toner particle as necessary. A charge control agent may also be added externally to the toner particle. By compound a charge control agent, it is possible to stabilize the charging properties and control the triboelectric charge quantity at a level appropriate to the developing system. A known charge control agent may be used, and a charge control agent capable of providing a rapid charging speed and stably maintaining a uniform charge quantity is especially desirable.

The charge control agents for giving the toner a negative charge include the following. Organic metal compounds and chelate compounds are effective, and examples include monoazo metal compounds, acetylacetone metal compounds, and metal compounds using aromatic oxycarboxylic acids, aromatic dicarboxylic acids, oxycarboxylic acids and dicarboxylic acids. Examples of charge control agents for giving the toner a positive charge include nigrosin, quaternary ammonium salts, metal salts of higher fatty acids, diorganotin borates, guanidine compounds and imidazole compounds. The content of the charge control agent is preferably from 0.01 to 20.0 mass parts, or more preferably from 0.5 to 10.0 mass parts per 100.0 mass parts of the toner particle.

The toner particle may be used as-is as a toner, but a toner may, if necessary, also be formed by mixing an external additive or the like so as to attach the external additive to the surface of the toner particle. Examples of the external additive include inorganic fine particles selected from the group consisting of silica fine particles, alumina fine particles and titania fine particles, and composite oxides of these. Examples of composite oxides include silica-aluminum fine particles and strontium titanate fine particles. The content of the external additive is preferably from 0.01 to 8.0 parts by mass, and more preferably from 0.1 to 4.0 parts by mass, relative to 100 parts by mass of the toner particle.

Within the scope of the present configuration, the toner particle may be manufactured by any known conventional method such as suspension polymerization, emulsion aggregation, dissolution suspension or pulverization, but is preferably manufactured by a suspension polymerization method.

The following describes the suspension polymerization method in detail. A polymerizable monomer composition is prepared by, for example, mixing the crystalline resin A synthesized in advance and polymerizable monomers for generating the amorphous resin, and other materials such as a colorant, a release agent, and a charge control agent, as necessary, and uniformly dissolving or dispersing the materials.

Thereafter, the polymerizable monomer composition is dispersed in an aqueous medium using a stirrer or the like to prepare a suspended particle of the polymerizable monomer composition. Thereafter, the polymerizable monomers contained in the particle are polymerized using an initiator or the like to obtain a toner particle.

After polymerization has finished, the toner particle is filtered, washed, and dried using known methods, and an external additive is added as necessary to obtain the toner.

A known polymerization initiator may be used. Examples of the polymerization initiator include: azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide polymerization initiators such as benzoyl peroxide, t-butyl peroxy-2-ethylhexanoate, t-butyl peroxypivalate, t-butyl peroxyisobutyrate, t-butyl peroxyneodecanoate, methylethylketone peroxide, diisopropyl peroxycarbonate, cumene hydroperoxide, 2,4-dichlorobenzoyl peroxide, and lauroyl peroxide. Also, the molecular weight may be adjusted using a known chain transfer agent or a known polymerization inhibitor.

The aqueous medium may contain an inorganic or organic dispersion stabilizer. A known dispersion stabilizer may be used. Examples of inorganic dispersion stabilizers include: phosphates such as hydroxyapatite, tribasic calcium phosphate, dibasic calcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

On the other hand, examples of organic dispersion stabilizers include polyvinyl alcohol, gelatin, methyl cellulose, methyl hydroxypropyl cellulose, ethyl cellulose, sodium salts of carboxymethyl cellulose, polyacrylic acid and salts thereof, and starch.

In the case where an inorganic compound is used as the dispersion stabilizer, a commercially available inorganic compound may be used as is, or the inorganic compound may be generated in an aqueous medium to obtain a finer particle. For example, in the case of calcium phosphate such as hydroxyapatite or tribasic calcium phosphate, an aqueous solution of the phosphate and an aqueous solution of a calcium salt may be mixed under high-speed stirring conditions.

The aqueous medium may contain a surfactant. A known surfactant may be used. Examples of the surfactant include: anionic surfactants such as sodium dodecylbenzenesulfate and sodium oleate; cationic surfactants; amphoteric surfactants; and nonionic surfactants.

The following describes methods for calculating and measuring various physical properties.

Method for Measuring Storage Elastic Modulus G′ and tan δ

The storage elastic modulus G′ and tan δ are measured using a viscoelasticity measurement apparatus (rheometer) ARES (manufactured by Rheometrics Scientific Inc.). An overview of the measurement is described in ARES operation manuals 902-30004 (August 1997) and 902-00153 (July 1993) issued by Rheometrics Scientific Inc., as follows.
Measurement jig: torsion rectangular
Measurement sample: A rectangular parallelepiped sample with a width of 12 mm, a height of 20 mm, and a thickness of 2.5 mm is produced from the toner using a pressure molding machine (25 kN is maintained for 30 minutes at normal temperature). A 100-kN press NT-100H manufactured by NPa System Co., Ltd., is used as the pressure molding machine.

After the jig and the sample are left to stand at normal temperature (23° C.) for 1 hour, the sample is attached to the jig (see the FIGURE). As shown in the FIGURE, the sample 100 is fixed in such a manner that a measurement portion have a width of 12.0 mm, a thickness of 2.5 mm, and a height of 10.0 mm. The sample 100 is fixed in the fixing holder 110 using the fixing screw 111. The reference number 120 is the motive power transmitting member 120. After the temperature is adjusted to a measurement start temperature of 30° C. for 10 minutes, measurement is carried out under the following settings.
Measurement frequency: 6.28 rad/s
Measurement strain setting: Initial value is set to 0.1%, and measurement is carried out in an automatic measurement mode.
Sample elongation correction: Adjusted in the automatic measurement mode.
Measurement temperature: The temperature is increased from 30° C. to 150° C. at a rate of 2° C./min.
Measurement interval: Viscoelasticity data is measured at intervals of 30 seconds, i.e., intervals of 1° C.

The data is transferred via an interface to RSI Orchestrator (soft for control, data collection and analysis) (manufactured by Rheometrics Scientific Inc.) that runs on Windows2000 manufactured by Microsoft Corporation.

In the measurement data, a temperature at which the storage elastic modulus G′ is 1.0×10⁷ Pa is taken as T1[° C.], a temperature at which the storage elastic modulus G′ is 3.0×10⁷ Pa is taken as T2[° C.], and a temperature at which the storage elastic modulus G′ is 3.0×10⁶ Pa is taken as T3[° C.]. Also, a ratio (tan δ) of the loss elastic modulus G″ to the storage elastic modulus G′ at the temperature T1[° C.] is taken as tan δ(T1), and tan δ at a temperature: T1-10[° C.] is taken as tan δ (T1-10).

Method for Separating Toner Particle from Toner

In the case where the surface of the toner particle is treated with an external additive or the like, in order to analyze the toner particle, the toner particle free of the external additive is obtained by separating the external additive using the following method.

160 g of sucrose (manufactured by Kishida Chemical Co., Ltd.) is added to 100 mL of ion exchanged water and dissolved by heating the vessel containing the mixture in hot water, and thus a thick sucrose solution is prepared. A dispersion liquid is produced by placing, in a centrifuge tube, 31 g of the thick sucrose solution above and 6 mL of Contaminon N (an aqueous solution containing, in an amount of 10 mass %, a neutral detergent for washing a precision measuring instrument (pH 7, constituted by a nonionic surfactant, an anionic surfactant, and an organic builder)).

1.0 g of the toner is added to this dispersion liquid, and a lump of the toner is loosen using a spatula or the like. The centrifuge tube is shaken using a shaker at 350 spm (strokes per minute) for 20 minutes. After the shaking is stopped, the solution is transferred to a glass tube (50 mL) for a swing rotor and is centrifuged using a centrifuge at 3500 rpm for 30 minutes. The toner particle and the detached external additive are separated by this operation.

It is visually confirmed that the toner is sufficiently separated from the aqueous solution, and then the separated toner forming the uppermost layer is collected using a spatula or the like. The collected toner is filtered using a vacuum filter and is then dried in a dryer for 1 hour or more, and thus the toner particle is obtained. The required amount of the toner particle is secured by performing this operation a plurality of times.

Method for Separating Crystalline Resin A from Toner Particle

The crystalline resin A can be separated from the toner using a known method, and the following describes an example of such a method. Gradient LC is used as a method for separating resin components from the toner. With this analysis, it is possible to separate resins included in the binder resin in accordance with polarities of the resins, irrespective of molecular weights.

First, the toner is dissolved in chloroform. Measurement is carried out using a sample that is prepared by adjusting the concentration of the sample to 0.1 mass % using chloroform and filtering the solution using a 0.45-μm PTFE filter. Gradient polymer LC measurement conditions are shown below.

Apparatus: UltiMate 3000 (manufactured by Thermo Fisher Scientific Inc.)

Mobile phase: A chloroform (HPLC), B acetonitrile (HPLC)

Gradient: 2 min (A/B=0/100)→25 min (A/B=100/0)

(The gradient of the change in mobile phase was adjusted to be linear.)

Flow rate: 1.0 mL/min

Injection: 0.1 mass %×20 μL

Column: Tosoh TSKgel ODS (4.6 mm φ×150 mm×5 μm)

Column temperature: 40° C.

Detector: Corona charged particle detector (Corona-CAD) (manufactured by Thermo Fisher Scientific Inc.)

In a time-intensity graph obtained through the measurement, the resin components can be separated into two peaks in accordance with their polarities. It is possible to separate the two types of resins by thereafter carrying out the above-described measurement again and performing isolation at times corresponding to valleys after the respective peaks.

DSC measurement is performed on the separated resins, and a resin that has a melting point peak is taken as the crystalline resin A.

Note that if the toner contains a release agent, it is necessary to separate the release agent from the toner. The release agent is separated by separating components having a molecular weight of 2000 or less using recycle HPLC. The following describes a measurement method.

First, a chloroform solution of the toner is prepared using the above-described method. The obtained solution is filtered using a solvent-resistant membrane filter “Maishori Disk” (manufactured by Tosoh Corporation) having a pore diameter of 0.2 m to obtain a sample solution. Note that the concentration of chloroform-soluble component in the sample solution is adjusted to 1.0 mass %. Measurement is carried out using the sample solution under the following conditions.
Apparatus: LC-Sakura NEXT (manufactured by Japan Analytical Industry Co., Ltd.)
Column: JAIGEL2H, 4H (manufactured by Japan Analytical Industry Co., Ltd.)
Eluent: chloroform

Flow rate: 10.0 ml/min
Oven temperature: 40.0° C.
Sample injection amount: 1.0 ml

The molecular weight of the sample is calculated using a molecular weight calibration curve obtained using standard polystyrene resins (e.g., “TSK standard polystyrene F-850, F-450, F-288, F-128, F-80, F-40, F-20, F-10, F-4, F-2, F-1, A-5000, A-2500, A-1000, A-500” (product name) manufactured by Tosoh Corporation).

The release agent is removed from the toner by repeatedly performing isolation of components having a molecular weight of 2000 or less using the obtained molecular weight curve.

Method for Measuring Percentage of Content of Monomer Unit (a) in Resin and Carbon Number of Alkyl Group

The percentage of the content of the monomer unit (a) in the resin and the carbon number of the alkyl group are measured using ¹H-NMR under the following conditions. The crystalline resin A isolated using the above-described method can be used as a measurement sample.

Measurement apparatus: FT NMR apparatus JNM-EX400 (manufactured by JEOL Ltd.)

Measurement frequency: 400 MHz

Pulse condition: 5.0 s

Frequency range: 10500 Hz

Cumulative number of times: 64 times

Measurement temperature: 30° C.

Sample: Prepared by placing 50 mg of a measurement sample in a sample tube having an inner diameter of 5 mm, adding deuterated chloroform (CDCl₃) as a solvent, and dissolving the measurement sample in a thermostatic chamber at 40° C. The structure of each monomer unit is identified by analyzing an obtained ¹H-NMR chart. The following describes measurement of the percentage of the content of the monomer unit (a) in the crystalline resin A and the carbon number of the alkyl group as an example.

In the obtained ¹H-NMR chart, a peak that is independent of peaks attributed to constituents of other monomer units is selected from among peaks attributed to constituents of the monomer unit (a), and an integration value S1 of the selected peak is calculated. An integration value is also calculated in the same manner with respect to other monomer units included in the crystalline resin A.

If monomer units constituting the crystalline resin A are the monomer unit (a) and another monomer unit, the percentage of the content of the monomer unit (a) is determined using the integration value S1 and an integration value S2 of a peak calculated for the other monomer unit. Note that n1 and n2 each represent the number of hydrogen atoms included in a constituent to which the peak focused on with respect to the corresponding unit is attributed.

Percentage (mol %) of content of monomer unit (a)={(S1/n1)/((S1/n1)+(S2/n2))}×100

In cases where the crystalline resin A includes two or more types of other monomer units, the percentage of the content of the monomer unit (a) can be calculated in the same manner (using S3 . . . . Sx and n3 . . . nx).

Also, the carbon number of the alkyl group can be calculated from the integration ratio of the proton peak in the ¹H-NMR chart.

If a polymerizable monomer that does not include a hydrogen atom in constituents other than a vinyl group is used, measurement is carried out using ¹³C-NMR and setting the measurement atomic nucleus to ¹³C in a single pulse mode, and calculation is performed in the same manner using ¹H-NMR. In addition, results from measurement of an infrared absorption spectrum (IR) and measurement using gas chromatography-mass spectrometry (GC-MS) may be used as necessary.

The percentage of the content of each monomer unit is converted to a value expressed in mass % by multiplying the percentage (mol %) of the monomer unit calculated as described above by the molecular weight of the monomer unit.

Measurement of Percentage of Content of Crystalline Resin A in Toner

The percentage of the content of the crystalline resin A in the toner is calculated on the basis of the mass of the toner before the toner is dissolved in chloroform and the mass of the crystalline resin A separated from the toner particle in the above-described method for separating the crystalline resin A from the toner particle.

Method for Separating Fatty Acid Metal Salt from Toner Particle

10.0 g of the toner particle from which the external additive has been separated is weighed and placed in thimble filter (No. 84, manufactured by Toyo Roshi Kaisha, Ltd.), and the thimble filter is set in a Soxhlet's extractor. 200 mL of tetrahydrofuran (THF) serving as a solvent is added, and then extraction is carried out for 20 hours. THF insoluble component that remains on the thimble filter is dried to a solid form. The obtained THF insoluble component is placed in thimble filter again, and the thimble filter is set in a Soxhlet's extractor. 200 ml of chloroform serving as a solvent is added, and then extraction is carried out for 8 hours. The fatty acid metal salt is separated from the toner particle by concentrating and drying the extract. The required amount of the fatty acid metal salt is obtained by repeating this operation as necessary.

Measurement of Carbon Number of Linear Fatty Acid in Linear Fatty Acid Metal Salt

After the fatty acid metal salt is extracted using the above-described method, the carbon number is measured using a method similar to the above-described method for measuring the carbon number of the alkyl group.

Identification of Valency of Metal in Linear Fatty Acid Metal Salt

After the fatty acid metal salt is extracted using the above-described method, the type of metal comprised in the linear fatty acid metal salt is analyzed using an inductively coupled plasma atomic emission spectrometer (ICP-AES (manufactured by Seiko Instruments Inc.)).

8.00 ml of 60% nitric acid (for atomic absorption spectrometry, manufactured by Kanto Chemical Co., Inc.) is added to 100.0 mg of the fatty acid metal salt, and thus acid decomposition is carried out as pretreatment. When the acid decomposition is carried out, the treatment is carried out in a hermetic container at an internal temperature of 220° C. for 1 hour using a microwave high-power sample pretreatment apparatus ETHOS1600 (manufactured by Milestone General K.K.), and thus a polyvalent metallic element-comprising solution sample is produced. Thereafter, ultrapure water is added such that the total mass is 50.00 g, and the resultant solution is used as a measurement sample. A calibration curve is produced for each metallic element, the type of metal comprised in the fatty acid metal salt is identified, and then the valency of the metal is identified on the basis of the type of metal. In the present disclosure, the expression “the metal in the linear fatty acid metal salt has a valency of 2 or more” means that the metal is a metal species of which a single-component metal ion can take on a valency of 2 or more.

Method for Measuring Amount of Metal in Toner Particle

In order to measure the amount of a metal in the toner particle, the measurement is carried out using X-ray fluorescence, and the amount is determined using a calibration curve method. The X-ray fluorescence measurement is carried out in conformity with JIS K 0119-1969, and is specifically carried out as follows.

A wavelength-dispersive X-ray fluorescence analyzer “Axios” (manufactured by PANalytical) is used as the measurement apparatus, and the attached software for setting the measurement conditions and analysis of measurement data “SuperQ ver.4.0F” (manufactured by PANalytical) is used. Note that Rh is used for an anode of an X-ray tube, the measurement atmosphere is vacuum, and the measurement diameter (collimator mask diameter) is 27 mm. Moreover, a proportional counter (PC) is used to measure a light element, and a scintillation counter (SC) is used to measure a heavy element.

Production of Calibration Curve for Aluminum Element

First, pellets to be used to produce a calibration curve for determining the amount of a metal in the toner particle are produced. 1.0 part by mass of aluminum hydroxide (Al(OH)₃) is added to 100 parts by mass of a binder (product name: Spectro Blend, composition: C 81.0, O 2.9, H 13.5, N 2.6 (mass %), chemical formula: C₁₉H₃₈ON, form: powder (44 μm); manufactured by Rigaku Corporation). The product is mixed well using a coffee mill, and thus a mixture is obtained.

The measurement pellet is obtained by molding the mixture using a tablet molding compressor “BRE-32” (manufactured by Maekawa Testing Machine MFG Co., Ltd.). 4 g of the mixture above is placed in a dedicated aluminum ring for pressing and is leveled out. Then, the mixture is pressed at 20 MPa for 60 seconds using the tablet molding compressor, and thus a molded pellet having a thickness of 2 mm and a diameter of 39 mm is prepared.

In a similar way, 10.0 parts by mass of aluminum hydroxide, 50.0 parts by mass of aluminum hydroxide, 200.0 parts by mass of aluminum hydroxide, and 500.0 parts by mass of aluminum hydroxide are each mixed with 100 parts by mass of the binder, and then pellets are produced by molding the obtained mixtures. The obtained pellets are analyzed using the wavelength-dispersive X-ray fluorescence analyzer with PET being used as an analyzing crystal, and the counting rate (unit: cps) of Al-Kα rays observed at a diffraction angle (20) of 144.8° is measured. At this time, the acceleration voltage and the current value of the X-ray generator are set to 32 kV and 125 mA, respectively, and the measurement time is 10 seconds.

A linear calibration curve with the vertical axis indicating the obtained counting rate of X rays and the horizontal axis indicating the concentration of added aluminum calculated from the addition amount of aluminum hydroxide in each sample for a calibration curve is obtained.

Quantification of Aluminum Element in Toner Particle

In order to quantify the amount of the aluminum element in the toner particle, 4 g of the toner particle is placed in a dedicated aluminum ring for pressing, and is molded into a pellet as in the case of the samples for producing a calibration curve. The molded toner particle pellet is measured under the same conditions as those for the calibration curve samples, and the amount (mass ppm) of the aluminum element in the toner particle is determined on the basis of the previously produced calibration curve.

Production of Calibration Curve for Magnesium Element and Quantification of Magnesium Element in Toner Particle

Calibration curve samples are produced in the same manner as describe above, except that magnesium hydroxide (Mg(OH)₂) is used as a metal component instead of aluminum hydroxide (Al(OH)₃). The samples are used to measure the counting rate (unit: cps) of Mg-Kα rays observed at a diffraction angle (20) of 22.93° when PET is used as an analyzing crystal, under the conditions where the acceleration voltage and the current value of the X-ray generator are set to 32 kV and 125 mA, respectively, and the measurement time is 50 seconds. Then, a calibration curve that is linearly correlated with the addition amount of a magnesium element is obtained.

In order to quantify the amount of magnesium in the toner particle, a toner particle sample is produced as in the case of the quantification of the aluminum element and is measured under the same conditions as those for the calibration curve samples, and the amount (mass ppm) of the magnesium element in the toner particle is determined on the basis of the calibration curve for a magnesium element.

Production of Calibration Curve for Calcium Element and Quantification of Calcium Element in Toner Particle

Calibration curve samples are produced in the same manner as describe above, except that calcium hydroxide (Ca(OH)₂) is used as a metal component instead of aluminum hydroxide (Al(OH)₃). The samples are used to measure the counting rate (unit: cps) of Ca-Kα rays observed at a diffraction angle (20) of 113.0° when PET is used as an analyzing crystal, under the conditions where the acceleration voltage and the current value of the X-ray generator are set to 32 kV and 125 mA, respectively, and the measurement time is 10 seconds. Then, a calibration curve that is linearly correlated with the addition amount of a calcium element is obtained.

In order to quantify the amount of calcium in the toner particle, a toner particle sample is produced as in the case of the quantification of the aluminum element and is measured under the same conditions as those for the calibration curve samples, and the amount (mass ppm) of the calcium element in the toner particle is determined on the basis of the calibration curve for a calcium element.

Production of Calibration Curve for Iron Element and Quantification of Iron Element in Toner Particle

Calibration curve samples are produced in the same manner as describe above, except that iron oxide (Fe₂O₃) is used as a metal component instead of aluminum hydroxide (Al(OH)₃). The samples are used to measure the counting rate (unit: cps) of Fe-Kα rays observed at a diffraction angle (20) of 57.480 when PET is used as an analyzing crystal, under the conditions where the acceleration voltage and the current value of the X-ray generator are set to 60 kV and 66 mA, respectively, and the measurement time is 10 seconds. Then, a calibration curve that is linearly correlated with the addition amount of an iron element is obtained.

In order to quantify the amount of iron in the toner particle, a toner particle sample is produced as in the case of the quantification of the aluminum element and is measured under the same conditions as those for the calibration curve samples, and the amount (mass ppm) of the iron element in the toner particle is determined on the basis of the calibration curve for an iron element.

Production of Calibration Curve for Another Metallic Element and Quantification of Said Metallic Element in Toner Particle

When an element other than the above-described elements is measured using X-ray fluorescence, the measurement is carried out under the conditions where the product of the tube voltage (kV) and the tube current (mA) of the tube of the X-ray generator is 4.0 kW and the measurement time is 10 seconds. The quantification is carried out in the same manner as in the case of the quantification of the aluminum element except for the above-described conditions.

The sum of the amounts of the metallic elements in the toner particle that are determined using the above-described method is taken as the metal amount in the toner particle.

### EXAMPLE

The following describes the present disclosure in more detail using examples, but the invention is not limited by the examples. In formulations described below, “parts” means “parts by mass”, unless otherwise stated.

Preparation of Crystalline Resin A1

The following materials were placed in a reaction vessel equipped with a reflux condenser tube, a stirrer, a thermometer, and a nitrogen introduction tube in a nitrogen atmosphere.

| | |
|---|---|
| Toluene | 100.0 parts |
| Monomer composition | 100.0 parts |

(The monomer composition was prepared by mixing the following monomers at a ratio shown below.)

(Docosyl acrylate (monomer (a)) 80.0 parts)
(Styrene 18.0 parts)
(Methacrylic acid 2.0 parts)

Polymerization initiator: t-butyl peroxypivalate (PERBUTYL PV manufactured by NOF Corporation) 0.5 parts

The contents in the reaction vessel were heated to 70° C. while being stirred at 200 rpm for 12 hours to cause a polymerization reaction, and thus a solution in which a polymer of the monomer composition was dissolved in toluene was obtained. Subsequently, the temperature of the solution was reduced to 25° C., and then the solution was added to 1000.0 parts of methanol while being stirred to cause precipitation of methanol-insoluble matter. The obtained methanol-insoluble matter was filtered, washed with methanol, and dried in a vacuum at 40° C. for 24 hours to obtain a crystalline resin A1.

Preparation of Crystalline Resins A2 to A11

Crystalline resins A2 to A11 were prepared in the same manner as in the preparation of the crystalline resin A1, except that the types and the addition amounts of the monomer compositions were changed as shown in Table 1.

TABLE 1

| | Monomer (a) for forming | | | | | | |
|---|---|---|---|---|---|---|---|
| | monomer unit (a) | | | Other monomer 1 | | Other monomer 2 | |
| | | | Addition | | Addition | | Addition |
| | | | amount | | amount | | amount |
| | Type | m | (part) | Type | (part) | Type | (part) |
| Resin A1 | Docosyl acrylate | 21 | 80.0 | Styrene | 18.0 | Methacrylic acid | 2.0 |
| Resin A2 | Docosyl acrylate | 21 | 35.0 | Styrene | 63.0 | Methacrylic acid | 2.0 |
| Resin A3 | Docosyl acrylate | 21 | 45.0 | Styrene | 53.0 | Methacrylic acid | 2.0 |
| Resin A4 | Docosyl acrylate | 21 | 55.0 | Styrene | 43.0 | Methacrylic acid | 2.0 |
| Resin A5 | Docosyl acrylate | 21 | 88.0 | Styrene | 10.0 | Methacrylic acid | 2.0 |
| Resin A6 | Docosyl acrylate | 21 | 93.0 | Styrene | 5.0 | Methacrylic acid | 2.0 |
| Resin A7 | Docosyl acrylate | 21 | 25.0 | Styrene | 73.0 | Methacrylic acid | 2.0 |
| Resin A8 | Hexadecyl acrylate | 15 | 80.0 | Styrene | 18.0 | Methacrylic acid | 2.0 |
| Resin A9 | Hentriacontyl acrylate | 30 | 80.0 | Styrene | 18.0 | Methacrylic acid | 2.0 |
| Resin A10 | Pentadecyl acrylate | 14 | 80.0 | Styrene | 18.0 | Methacrylic acid | 2.0 |
| Resin A11 | Tritriacontyl acrylate | 32 | 80.0 | Styrene | 18.0 | Methacrylic acid | 2.0 |

### Example 1

Manufacture of Toner through Suspension Polymerization Method

Manufacture of Toner Particle 1

| | |
|---|---|
| Styrene | 50.0 parts |
| Colorant: Pigment blue 15:3 | 6.5 parts |

A mixture of the above materials was prepared. The mixture was placed in an attritor (manufactured by Nippon Coke & Engineering Co., Ltd.) and dispersed at 200 rpm for 2 hours using zirconia beads having a diameter of 5 mm to obtain a raw material dispersed solution.

On the other hand, 735.0 parts of ion exchange water and 16.0 parts of tribasic sodium phosphate (dodeca hydrate) were added into a vessel equipped with a high-speed stirrer Homomixer (manufactured by Primix Corporation) and a thermometer, and heated to 60° C. while being stirred at 12000 rpm. A calcium chloride aqueous solution obtained by dissolving 9.0 parts of calcium chloride (dihydrate) in 65.0 parts of ion exchange water was added into the vessel, and the contents in the vessel were stirred at 12000 rpm for 30 minutes while the temperature was kept at 60° C. Then, 10% hydrochloric acid was added to adjust pH to 6.0, and thus an aqueous medium in which an inorganic dispersion stabilizer containing hydroxyapatite was dispersed in water was obtained.

Subsequently, the raw material dispersed solution described above was transferred into a vessel equipped with a stirrer and a thermometer, and heated to 60° C. while being stirred at 100 rpm.

| | |
|---|---|
| Crystalline Resin A1: | 50.0 parts |
| Release agent: | 9.0 parts |

(Release agent: DP18 (dipentaerythritol stearate wax, melting point: 79° C., manufactured by Nippon Seiro Co., Ltd.)

| | |
|---|---|
| Crosslinking agent (divinylbenzene) | 0.05 parts |
| Fatty acid metal salt (aluminum distearate) | 0.5 parts |

The materials shown above were added into the vessel, the contents in the vessel were stirred at 100 rpm for 30 minutes while the temperature was kept at 60° C., then 9.0 parts of t-butyl peroxypivalate (PERBUTYL PV manufactured by NOF Corporation) was added as a polymerization initiator, and the contents were further stirred for 1 minute, and then added into the aqueous medium that was being stirred at 12000 rpm using the high-speed stirrer. Stirring by the high-speed stirrer was continued at 12000 rpm for 20 minutes while the temperature was kept at 60° C. to obtain a granulation solution.

The granulation solution was transferred into a reaction vessel equipped with a reflux condenser tube, a stirrer, a thermometer, and a nitrogen introduction tube, and heated to 70° C. while being stirred at 150 rpm in a nitrogen atmosphere. Polymerization was carried out for 12 hours at 150 rpm while the temperature was kept at 70° C. to obtain a toner particle dispersed solution.

The obtained toner particle dispersed solution was cooled to 45° C. while being stirred at 150 rpm, and then subjected to heat treatment for 5 hours while the temperature was kept at 45° C. Thereafter, dilute hydrochloric acid was added until pH reached 1.5 while stirring was continued to dissolve the dispersion stabilizer. Solid contents were filtered, sufficiently washed with ion exchange water, and then dried in a vacuum at 30° C. for 24 hours to obtain a toner particle 1.

Preparation of Toner 1

2.0 parts of silica fine particles (subjected to hydrophobic treatment performed using hexamethyldisilazane, number-average particle diameter of primary particles: 10 nm, BET specific surface area: 170 m²/g) was added as an external additive with respect to 98.0 parts of the toner particle 1, and the mixture was mixed at 3000 rpm for 15 minutes using a Henschel mixer (manufactured by Nippon Coke & Engineering Co., Ltd.) to obtain a toner 1.

Tables 3-1 and 3-2 shows the physical properties of the obtained toner 1. Moreover, Tables 4-1 and 4-2 shows the evaluation results obtained through a toner evaluation method, which will be described later.

TABLE 2-1

| | | | | | Crosslinking | | | | Release |
|---|---|---|---|---|---|---|---|---|---|
| | | Crystalline Resin A | | | agent | Linear fatty acid metal salt | | | agent |
| | | | Addition | | Addition | | Addition | | Addition |
| Toner | | | amount | Styrene | amount | | amount | Metal | amount |
| No. | Toner particle | Type | (part) | Parts | (part) | Type | (part) | valency | (part) |
| Toner 1 | Toner particle 1 | Resin A1 | 50.0 | 50.0 | 0.05 | Aluminum distearate | 0.5 | 3 | 9.0 |
| Toner 2 | Toner particle 2 | Resin A2 | 50.0 | 50.0 | 0.05 | Aluminum distearate | 0.5 | 3 | 9.0 |
| Toner 3 | Toner particle 3 | Resin A3 | 50.0 | 50.0 | 0.05 | Aluminum distearate | 0.5 | 3 | 9.0 |
| Toner 4 | Toner particle 4 | Resin A4 | 50.0 | 50.0 | 0.05 | Aluminum distearate | 0.5 | 3 | 9.0 |
| Toner 5 | Toner particle 5 | Resin A5 | 50.0 | 50.0 | 0.05 | Aluminum distearate | 0.5 | 3 | 9.0 |
| Toner 6 | Toner particle 6 | Resin A6 | 50.0 | 50.0 | 0.05 | Aluminum distearate | 0.5 | 3 | 9.0 |
| Toner 7 | Toner particle 7 | Resin A8 | 50.0 | 50.0 | 0.05 | Aluminum distearate | 0.5 | 3 | 9.0 |
| Toner 8 | Toner particle 8 | Resin A9 | 50.0 | 50.0 | 0.05 | Calcium montanate | 0.5 | 2 | 9.0 |
| Toner 9 | Toner particle 9 | Resin A1 | 25.0 | 75.0 | 0.05 | Aluminum distearate | 0.5 | 3 | 9.0 |
| Toner 10 | Toner particle 10 | Resin A1 | 100.0 | 0.0 | 0.05 | Aluminum distearate | 0.5 | 3 | 9.0 |
| Toner 11 | Toner particle 11 | Resin A1 | 50.0 | 50.0 | 0.10 | Aluminum distearate | 0.5 | 3 | 9.0 |
| Toner 12 | Toner particle 12 | Resin A1 | 50.0 | 50.0 | 0.02 | Aluminum distearate | 0.5 | 3 | 9.0 |
| Toner 13 | Toner particle 13 | Resin A1 | 60.0 | 40.0 | 0.08 | Aluminum distearate | 0.5 | 3 | 9.0 |
| Toner 14 | Toner particle 14 | Resin A1 | 40.0 | 60.0 | 0.03 | Aluminum distearate | 0.5 | 3 | 9.0 |
| Toner 15 | Toner particle 15 | Resin A1 | 50.0 | 50.0 | 0.05 | Calcium laurate | 0.5 | 2 | 9.0 |
| Toner 16 | Toner particle 16 | Resin A1 | 50.0 | 50.0 | 0.05 | Calcium montanate | 0.5 | 2 | 9.0 |
| Toner 17 | Toner particle 17 | Resin A1 | 50.0 | 50.0 | 0.05 | Aluminum distearate | 0.015 | 3 | 9.0 |
| Toner 18 | Toner particle 18 | Resin A1 | 50.0 | 50.0 | 0.05 | Aluminum distearate | 0.05 | 3 | 9.0 |
| Toner 19 | Toner particle 19 | Resin A1 | 50.0 | 50.0 | 0.05 | Aluminum distearate | 0.95 | 3 | 9.0 |
| Toner 20 | Toner particle 20 | Resin A1 | 50.0 | 50.0 | 0.05 | Aluminum distearate | 1.05 | 3 | 9.0 |
| Toner 21 | Toner particle 21 | Resin A1 | 45.0 | 55.0 | 0.05 | Aluminum distearate | 0.5 | 3 | 9.0 |
| Toner 22 | Toner particle 22 | Resin A1 | 40.0 | 60.0 | 0.05 | Aluminum distearate | 0.5 | 3 | 9.0 |

TABLE 2-2

| | | | | | | | | | Release |
|---|---|---|---|---|---|---|---|---|---|
| | | Crystalline Resin A | | | Crosslinking | Linear fatty acid metal salt | | | agent |
| | | | Addition | | Addition | | Addition | | Addition |
| Toner | | | amount | Styrene | amount | | amount | Metal | amount |
| No. | Toner particle | Type | (part) | Parts | (part) | Type | (part) | valency | (part) |
| Comparative | Comparative | Resin A7 | 50.0 | 50.0 | 0.05 | Aluminum distearate | 0.5 | 3 | 9.0 |
| toner 1 | toner particle 1 | | | | | | | | |
| Comparative | Comparative | Resin A10 | 50.0 | 50.0 | 0.05 | Aluminum distearate | 0.5 | 3 | 9.0 |
| toner 2 | toner particle 2 | | | | | | | | |
| Comparative | Comparative | Resin A11 | 50.0 | 50.0 | 0.05 | Aluminum distearate | 0.5 | 3 | 9.0 |
| toner 3 | toner particle 3 | | | | | | | | |
| Comparative | Comparative | Resin A1 | 17.0 | 83.0 | 0.05 | Aluminum distearate | 0.5 | 3 | 9.0 |
| toner 4 | toner particle 4 | | | | | | | | |
| Comparative | Comparative | Resin A1 | 100.0 | 0.0 | 0.05 | Aluminum distearate | 0.5 | 3 | 0.0 |
| toner 5 | toner particle 5 | | | | | | | | |
| Comparative | Comparative | Resin A1 | 50.0 | 50.0 | 0.15 | Aluminum distearate | 0.5 | 3 | 9.0 |
| toner 6 | toner particle 6 | | | | | | | | |
| Comparative | Comparative | Resin A1 | 50.0 | 50.0 | 0.00 | Aluminum distearate | 0.5 | 3 | 9.0 |
| toner 7 | toner particle 7 | | | | | | | | |
| Comparative | Comparative | Resin A1 | 65.0 | 35.0 | 0.10 | Aluminum distearate | 0.5 | 3 | 9.0 |
| toner 8 | toner particle 8 | | | | | | | | |
| Comparative | Comparative | Resin A1 | 35.0 | 65.0 | 0.02 | Aluminum distearate | 0.5 | 3 | 9.0 |
| toner 9 | toner particle 9 | | | | | | | | |
| Comparative | Comparative | Resin A1 | 50.0 | 50.0 | 0.05 | Aluminum caprylate | 0.5 | 3 | 9.0 |
| toner 10 | toner particle 10 | | | | | | | | |
| Comparative | Comparative | Resin A1 | 50.0 | 50.0 | 0.05 | Sodium distearate | 0.5 | 1 | 9.0 |
| toner 11 | toner particle 11 | | | | | | | | |

In Tables 2-1 and 2-2 above, the term “metal valency” refers to the valency of the metallic element in the linear fatty acid metal salt in the toner particle.

Examples 2 to 22, Comparative Examples 1 to 11

Toner particles 2 to 22 and comparative toner particles 1 to 11 were obtained in the same manner as in Example 1, except that the materials used and the addition amounts were changed as shown in Tables 2-1 and 2-2. Tables 2-1 and 2-2 shows the physical properties of the obtained toner particles.

Furthermore, toners 2 to 22 and comparative toners 1 to 11 were obtained by adding an external additive in the same manner as in Example 1. Tables 3-1 and 3-2 shows the physical properties of the toners. Moreover, Tables 4-1 and 4-2 shows the evaluation results obtained through a toner evaluation method, which will be described later. It was confirmed through the above-described analysis that each of toners 1 to 22 and the comparative toners 1 to 11 contained the monomer units forming the crystalline resin A at the same ratio as that in the formulation shown in Table 1.

TABLE 3-1

| | | Amount of | Amount of | | | |
|---|---|---|---|---|---|---|
| | | monomer | crystalline | | | |
| | | unit (a) | resin A | | | \|C(a) − |
| | Toner | (mass %) | (mass %) | C(a) | C(b) | C(b)\| |
| Example 1 | Toner 1 | 80.0 | 43.1 | 22 | 18 | 4 |
| Example 2 | Toner 2 | 35.0 | 43.1 | 22 | 18 | 4 |
| Example 3 | Toner 3 | 45.0 | 43.1 | 22 | 18 | 4 |
| Example 4 | Toner 4 | 55.0 | 43.1 | 22 | 18 | 4 |
| Example 5 | Toner 5 | 88.0 | 43.1 | 22 | 18 | 4 |
| Example 6 | Toner 6 | 93.0 | 43.1 | 22 | 18 | 4 |
| Example 7 | Toner 7 | 80.0 | 43.1 | 16 | 18 | 2 |
| Example 8 | Toner 8 | 80.0 | 43.1 | 31 | 28 | 3 |
| Example 9 | Toner 9 | 80.0 | 21.5 | 22 | 18 | 4 |
| Example 10 | Toner 10 | 80.0 | 86.2 | 22 | 18 | 4 |
| Example 11 | Toner 11 | 80.0 | 43.1 | 22 | 18 | 4 |
| Example 12 | Toner 12 | 80.0 | 43.1 | 22 | 18 | 4 |
| Example 13 | Toner 13 | 80.0 | 51.7 | 22 | 18 | 4 |
| Example 14 | Toner 14 | 80.0 | 34.5 | 22 | 18 | 4 |
| Example 15 | Toner 15 | 80.0 | 43.1 | 22 | 12 | 10 |
| Example 16 | Toner 16 | 80.0 | 43.1 | 22 | 28 | 6 |
| Example 17 | Toner 17 | 80.0 | 43.3 | 22 | 18 | 4 |
| Example 18 | Toner 18 | 80.0 | 43.3 | 22 | 18 | 4 |
| Example 19 | Toner 19 | 80.0 | 42.9 | 22 | 18 | 4 |
| Example 20 | Toner 20 | 80.0 | 42.9 | 22 | 18 | 4 |
| Example 21 | Toner 21 | 35.0 | 38.8 | 22 | 18 | 4 |
| Example 22 | Toner 22 | 35.0 | 34.5 | 22 | 18 | 4 |
| Comparative example 1 | Comparative toner 1 | 25.0 | 43.1 | 22 | 18 | 4 |
| Comparative example 2 | Comparative toner 2 | 80.0 | 43.1 | 15 | 18 | 3 |
| Comparative example 3 | Comparative toner 3 | 80.0 | 43.1 | 33 | 18 | 15 |
| Comparative example 4 | Comparative toner 4 | 80.0 | 14.6 | 22 | 18 | 4 |
| Comparative example 5 | Comparative toner 5 | 80.0 | 93.4 | 22 | 18 | 4 |
| Comparative example 6 | Comparative toner 6 | 80.0 | 43.0 | 22 | 18 | 4 |
| Comparative example 7 | Comparative toner 7 | 80.0 | 43.1 | 22 | 18 | 4 |
| Comparative example 8 | Comparative toner 8 | 80.0 | 56.0 | 22 | 18 | 4 |
| Comparative example 9 | Comparative toner 9 | 80.0 | 30.2 | 22 | 18 | 4 |
| Comparative example 10 | Comparative toner 10 | 80.0 | 43.1 | 22 | 8 | 14 |
| Comparative example 11 | Comparative toner 11 | 80.0 | 43.1 | 22 | 18 | 4 |

TABLE 3-2

| | | Metal amount | T1 | | tanδ(T1)/ | \|T3 − |
|---|---|---|---|---|---|---|
| | Toner | (mass ppm) | (° C.) | tanδ(T1) | tanδ(T1-10) | T2\| |
| Example 1 | Toner 1 | 100.0 | 60.0 | 0.6 | 1.7 | 6.3 |
| Example 2 | Toner 2 | 100.0 | 68.0 | 0.6 | 1.7 | 8.0 |
| Example 3 | Toner 3 | 100.0 | 65.0 | 0.6 | 1.7 | 7.5 |
| Example 4 | Toner 4 | 100.0 | 62.0 | 0.6 | 1.7 | 7.0 |
| Example 5 | Toner 5 | 100.0 | 56.0 | 0.6 | 1.7 | 5.5 |
| Example 6 | Toner 6 | 100.0 | 52.0 | 0.6 | 1.7 | 5.0 |
| Example 7 | Toner 7 | 100.0 | 60.0 | 0.6 | 1.7 | 6.3 |
| Example 8 | Toner 8 | 100.0 | 60.0 | 0.6 | 1.7 | 6.3 |
| Example 9 | Toner 9 | 100.0 | 68.0 | 0.6 | 1.7 | 6.3 |
| Example 10 | Toner 10 | 100.0 | 52.0 | 0.6 | 1.7 | 6.3 |
| Example 11 | Toner 11 | 100.0 | 60.0 | 0.4 | 1.7 | 6.3 |
| Example 12 | Toner 12 | 100.0 | 60.0 | 1.0 | 1.7 | 6.3 |
| Example 13 | Toner 13 | 100.0 | 60.0 | 0.6 | 1.1 | 6.3 |
| Example 14 | Toner 14 | 100.0 | 60.0 | 0.6 | 1.9 | 6.3 |
| Example 15 | Toner 15 | 100.0 | 60.0 | 0.6 | 1.7 | 6.3 |
| Example 16 | Toner 16 | 100.0 | 60.0 | 0.6 | 1.7 | 6.3 |
| Example 17 | Toner 17 | 3.0 | 60.0 | 0.6 | 1.7 | 6.3 |
| Example 18 | Toner 18 | 10.0 | 60.0 | 0.6 | 1.7 | 6.3 |
| Example 19 | Toner 19 | 190.0 | 60.0 | 0.6 | 1.7 | 6.3 |
| Example 20 | Toner 20 | 210.0 | 60.0 | 0.6 | 1.7 | 6.3 |
| Example 21 | Toner 21 | 100.0 | 60.0 | 0.6 | 1.7 | 9.0 |
| Example 22 | Toner 22 | 100.0 | 60.0 | 0.6 | 1.7 | 11.0 |
| Comparative example 1 | Comparative toner 1 | 100.0 | 72.0 | 0.6 | 1.7 | 10.0 |
| Comparative example 2 | Comparative toner 2 | 100.0 | 60.0 | 0.6 | 1.7 | 6.3 |
| Comparative example 3 | Comparative toner 3 | 100.0 | 60.0 | 0.6 | 1.7 | 6.3 |
| Comparative example 4 | Comparative toner 4 | 100.0 | 75.0 | 0.6 | 1.7 | 6.3 |
| Comparative example 5 | Comparative toner 5 | 100.0 | 45.0 | 0.6 | 1.7 | 6.3 |
| Comparative example 6 | Comparative toner 6 | 100.0 | 60.0 | 0.2 | 1.7 | 6.3 |
| Comparative example 7 | Comparative toner 7 | 100.0 | 60.0 | 1.1 | 1.7 | 6.3 |
| Comparative example 8 | Comparative toner 8 | 100.0 | 60.0 | 0.6 | 1.1 | 6.3 |
| Comparative example 9 | Comparative toner 9 | 100.0 | 60.0 | 0.6 | 2.0 | 6.3 |
| Comparative example 10 | Comparative toner 10 | 100.0 | 60.0 | 0.6 | 1.7 | 6.3 |
| Comparative example 11 | Comparative toner 11 | 100.0 | 60.0 | 0.6 | 1.7 | 6.3 |

In Tables 3-1 and 3-2 above, the term “Amount of monomer unit (a)” refers to the percentage of the content of the monomer unit (a) in the crystalline resin A. Also, the term “Amount of crystalline resin A” refers to the amount of the crystalline resin A in the toner. The term “Metal amount” refers to sum of the amounts of the metals contained in the toner particle that were measured using the above-described method.

<1> Low-Temperature Fixability

A process cartridge filled respectively with the toner 1 to 22 and comparative toner 1 to 11 was left to stand in an environment at a temperature of 25° C. and a humidity of 40% RH for 48 hours. An unfixed image of rectangular image patterns having a size of 10 mm×10 mm and arranged at 9 points at regular intervals over the entire transfer paper was output using LBP-712Ci that had been modified so as to operate even if a fixing unit was removed. A toner laid-on level on the transfer paper was set to 0.80 mg/cm², and a fixing onset temperature was evaluated. Note that A4 paper (“prober bond paper” manufactured by Fox River Paper Co., 105 g/m²) was used as the transfer paper.

The fixing unit of LBP-712Ci was taken out, and an external fixing unit configured to operate even outside a laser beam printer was used. The image was fixed using the external fixing unit at a process speed of 260 mm/sec by increasing the fixation temperature each time by 5° C. from 90° C.

The fixed image was visually observed, and the lowest temperature at which cold offset did not occur was taken as the fixing onset temperature, and low-temperature fixability was evaluated based on the following criteria. Evaluation results are shown in Table 4-1.

Evaluation Criteria

A: The fixing onset temperature was 100° C. or lower.

B: The fixing onset temperature was from 105° C. to 110° C.

C: The fixing onset temperature was from 115° C. to 120° C.

D: The fixing onset temperature exceeds 120° C.

<2> Evaluation of Heat-Resistant Storability/Blocking Resistance

After 10 g of the toner was placed in a 100-mL resin cup and was left to stand in an environment at a temperature of 45° C. and a humidity of 95% for 7 days, the degree of agglomeration was visually confirmed, and the heat-resistant storability was evaluated on the basis of criteria shown below. Table 4-1 shows the evaluation results.

Evaluation Criteria

A: No agglomerates were observed.

B: Agglomerates were observed, but easily disintegrated.

C: Agglomerates were observed, but disintegrated when shaken.

D: Agglomerates could be held, and were hard to disintegrate.

<3> Evaluation of Gloss and Gloss Non-Uniformity

The fixed image fixed at the fixing onset temperature in the evaluation <1> described above was used. A gloss value was measured using a handy gloss meter PG-1 (manufactured by Nippon Denshoku Industries Co., Ltd.). The gloss value was measured for each of the image patterns arranged at 9 points with a light emitting angle and a light receiving angle set to 75°, and an average value of the measured gloss values was evaluated. Also, gloss non-uniformity was evaluated based on a standard deviation of the measured values. Evaluation results are shown in Table 4-2.

Gloss Evaluation Criteria

A: The average gloss value was 25.0 or more.

B: The average gloss value was 20.0 or more and less than 25.0.

C: The average gloss value was 15.0 or more and less than 20.0.

D: The average gloss value was less than 15.0.

Gloss Non-Uniformity Evaluation Criteria

A: The standard deviation of gloss was 1.00 or less.

B: The standard deviation of gloss was more than 1.00 and 2.00 or less.

C: The standard deviation of gloss was more than 2.00 and 3.00 or less.

D: The standard deviation of gloss was more than 3.00.

<4> Evaluation of Hot-Offset Resistance

A solid image (toner laid-on level: 0.9 mg/cm²) was formed in an environment at normal temperature and normal humidity (25° C./50% RH) at a process speed of 260 mm/sec while the fixing temperature was raised by 10° C. Regular paper (LETTER-size XEROX 4200 sheet, manufactured by XEROX, 75 g/m²) was used as a transfer material. The occurrence of hot offset was visually confirmed, and evaluation was carried out based on criteria shown below, which depend on the temperature at which the hot offset occurred. Table 4-2 shows the evaluation results.

Evaluation Criteria for Hot-Offset Resistance

A: Offset occurred at a temperature of 160° C. or higher.

B: Offset occurred at a temperature from 150° C. up to but not including 160° C.

C: Offset occurred at a temperature from 140° C. up to but not including 150° C.

D: Offset occurred at a temperature of less than 140° C.

TABLE 4-1

| | | Low- | | |
|---|---|---|---|---|
| | | temperature | | |
| | | Fixing | | |
| | | onset | Eval- | Heat- |
| | | temper- | ua- | resistant |
| | | ature | tion | stor- |
| | Toner | (° C.) | rank | ability |
| Example 1 | Toner 1 | 100 | A | A |
| Example 2 | Toner 2 | 120 | C | A |
| Example 3 | Toner 3 | 115 | C | A |
| Example 4 | Toner 4 | 110 | B | A |
| Example 5 | Toner 5 | 95 | A | B |
| Example 6 | Toner 6 | 90 | A | C |
| Example 7 | Toner 7 | 110 | B | C |
| Example 8 | Toner 8 | 115 | C | A |
| Example 9 | Toner 9 | 120 | C | A |
| Example 10 | Toner 10 | 90 | A | C |
| Example 11 | Toner 11 | 100 | A | A |
| Example 12 | Toner 12 | 100 | A | A |
| Example 13 | Toner 13 | 100 | A | A |
| Example 14 | Toner 14 | 100 | A | A |
| Example 15 | Toner 15 | 115 | C | A |
| Example 16 | Toner 16 | 110 | B | A |
| Example 17 | Toner 17 | 100 | A | A |
| Example 18 | Toner 18 | 100 | A | A |
| Example 19 | Toner 19 | 110 | B | A |
| Example 20 | Toner 20 | 115 | C | A |
| Example 21 | Toner 21 | 110 | B | A |
| Example 22 | Toner 22 | 115 | C | A |
| Comparative example 1 | Comparative toner 1 | 130 | D | A |
| Comparative example 2 | Comparative toner 2 | 120 | C | D |
| Comparative example 3 | Comparative toner 3 | 125 | D | A |
| Comparative example 4 | Comparative toner 4 | 130 | D | A |
| Comparative example 5 | Comparative toner 5 | 90 | A | D |
| Comparative example 6 | Comparative toner 6 | 100 | A | A |
| Comparative example 7 | Comparative toner 7 | 100 | A | A |
| Comparative example 8 | Comparative toner 8 | 100 | A | A |
| Comparative example 9 | Comparative toner 9 | 100 | A | A |
| Comparative | Comparative | 130 | D | A |
| example 10 | toner 10 | | | |
| Comparative | Comparative | 100 | A | A |
| example 11 | toner 11 | | | |

TABLE 4-2

| | | | | | | Hot-offset resistance | |
|---|---|---|---|---|---|---|---|
| | | Gloss uniformity | | | | Hot-offset | |
| | | Average | | Standard | | Occurrence | |
| | | Gloss | Evaluation | Deviation | Evaluation | temperature | Evaluation |
| | Toner | value | rank | of gloss | rank | (° C.) | rank |
| Example 1 | Toner 1 | 26 | A | 0.8 | A | 165 | A |
| Example 2 | Toner 2 | 26 | A | 0.8 | A | 165 | A |
| Example 3 | Toner 3 | 26 | A | 0.8 | A | 165 | A |
| Example 4 | Toner 4 | 26 | A | 0.8 | A | 165 | A |
| Example 5 | Toner 5 | 26 | A | 0.8 | A | 165 | A |
| Example 6 | Toner 6 | 26 | A | 0.8 | A | 165 | A |
| Example 7 | Toner 7 | 26 | A | 0.8 | A | 170 | A |
| Example 8 | Toner 8 | 26 | A | 0.8 | A | 170 | A |
| Example 9 | Toner 9 | 26 | A | 0.8 | A | 165 | A |
| Example 10 | Toner 10 | 18 | C | 2.5 | C | 140 | C |
| Example 11 | Toner 11 | 17 | C | 2.3 | C | 165 | A |
| Example 12 | Toner 12 | 16 | C | 2.7 | C | 165 | A |
| Example 13 | Toner 13 | 15 | C | 0.6 | A | 155 | B |
| Example 14 | Toner 14 | 26 | A | 2.5 | C | 155 | B |
| Example 15 | Toner 15 | 26 | A | 0.8 | A | 140 | C |
| Example 16 | Toner 16 | 26 | A | 0.8 | A | 145 | C |
| Example 17 | Toner 17 | 26 | A | 0.8 | A | 140 | C |
| Example 18 | Toner 18 | 26 | A | 0.8 | A | 150 | B |
| Example 19 | Toner 19 | 26 | A | 0.8 | A | 165 | A |
| Example 20 | Toner 20 | 26 | A | 0.8 | A | 170 | A |
| Example 21 | Toner 21 | 26 | A | 0.8 | A | 165 | A |
| Example 22 | Toner 22 | 26 | A | 0.8 | A | 165 | A |
| Comparative example 1 | Comparative toner 1 | 26 | A | 0.8 | A | 170 | A |
| Comparative example 2 | Comparative toner 2 | 26 | A | 0.8 | A | 170 | A |
| Comparative example 3 | Comparative toner 3 | 26 | A | 0.8 | A | 130 | D |
| Comparative example 4 | Comparative toner 4 | 26 | A | 0.8 | A | 165 | A |
| Comparative example 5 | Comparative toner 5 | 13 | D | 3.5 | D | 135 | D |
| Comparative example 6 | Comparative toner 6 | 12 | D | 3.3 | D | 165 | A |
| Comparative example 7 | Comparative toner 7 | 10 | D | 3.7 | D | 165 | A |
| Comparative example 8 | Comparative toner 8 | 10 | D | 0.6 | A | 145 | C |
| Comparative example 9 | Comparative toner 9 | 26 | A | 3.5 | D | 145 | C |
| Comparative example 10 | Comparative toner 10 | 26 | A | 0.8 | A | 135 | D |
| Comparative example 11 | Comparative toner 11 | 26 | A | 0.8 | A | 130 | D |

As is clear from Tables 4-1 and 4-2, in Examples 1 to 22, it is possible to provide a toner that has excellent low-temperature fixability, heat-resistant storability, and hot-offset resistance, and shows excellent gloss uniformity on rough paper, compared with Comparative Examples 1 to 11.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2022-100447, filed Jun. 22, 2022, which is hereby incorporated by reference herein in its entirety.

What is claimed is:

1. A toner comprising a toner particle, the toner particle comprising a binder resin,
wherein the binder resin comprises a crystalline resin A,
(i) the crystalline resin A comprises a monomer unit (a) represented by formula (1): 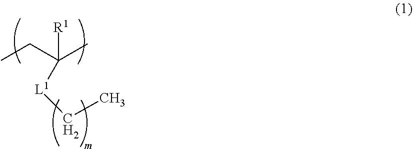
in formula (1), R¹ represents a hydrogen atom or a methyl group, L¹ represents a single bond, an ester bond, or an amide bond, and m represents an integer from 15 to 30,
(ii) a percentage of a content of the monomer unit (a) in the crystalline resin A is 30.0 mass % or more,
(iii) the monomer unit (a) comprises an alkyl group of which carbon number C(a) is 16 to 31, and
(iv) a content of the crystalline resin A in the toner is 20.0 to 90.0 mass %,
when, in measurement of viscoelasticity of the toner, T1 (° C.) represents a temperature at which a storage elastic modulus G′ of the toner is 1.0×10⁷ Pa, tan δ(T1) represents a ratio (tan δ) of a loss elastic modulus G″ of the toner to the storage elastic modulus G′ of the toner at the temperature T1 (° C.), and tan δ(T1-10) represents tan δ at a temperature T1-10 (° C.),
the T1, the tan δ(T1), and the tan δ(T1-10) satisfy expressions (2) to (4),
50.0≤T1≤70.0 (2)
0.3≤tan δ(T1)≤1.0 (3)
1.0≤tan δ(T1)/tan δ(T1-10)≤1.9 (4)
the toner particle comprises a linear fatty acid metal salt,
a carbon number C(a) of the alkyl group and a carbon number C(b) of a linear fatty acid in the linear fatty acid metal salt satisfy |C(a)−C(b)|≤10, and
a metal in the linear fatty acid metal salt has a valency of 2 or more.

2. The toner according to claim 1, wherein an amount of a metallic element in the toner particle is 5.0 to 200.0 mass ppm.

3. The toner according to claim 1, wherein the carbon number C(a) of the alkyl group and the carbon number C(b) of the linear fatty acid in the linear fatty acid metal salt satisfy |C(a)−C(b)|≤5.

4. The toner according to claim 1, wherein the metal in the linear fatty acid metal salt is a trivalent metal.

5. The toner according to claim 1, wherein the percentage of the content of the monomer unit (a) in the crystalline resin A is 50.0 to 90.0 mass %.

6. The toner according to claim 1, wherein,
when, in measurement of viscoelasticity of the toner, T2 (° C.) represents a temperature at which the storage elastic modulus G′ of the toner is 3.0×10⁷ Pa, r; and T3 (° C.) represents a temperature at which the storage elastic modulus G′ of the toner is 3.0×10⁶ Pa,
the T2 and the T3 satisfy an expression (5) below:

|T3−T2|≤10.0 (5).

7. The toner according to claim 1, wherein the linear fatty acid metal salt is at least one selected from the group consisting of aluminum distearate, calcium montanate, and calcium laurate.
